(19) United States
(12) Patent Application Publication
(10) Pub. No.: US 2002/0061756 A1
(43) Pub. Date: May 23, 2002

(54) Paging co-ordination in telecommunication networks

(76) Inventors: Peter Nils Olov Bleckert, Uppsala (SE); Lars Martin Backstrom, Danderyd (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/887,130

(22) Filed: Jun. 22, 2001

Related U.S. Application Data
(60) Provisional application No. 60/249,284, filed on Nov. 17, 2000.

(51) Int. Cl. H04Q 7/20

(52) U.S. Cl. 455/458; 455/426; 455/567

(57) ABSTRACT

A serving GPRS support node in a packet-switched portion of a communication network is registered in a mobile switching center (MSC) node in a circuit-switched portion of the network as a “virtual” circuit-switched node, in particular a base station controller of the like, instead of as an SGSN. The virtual BSC has one virtual cell with a unique Location-Area identity that is included in the search area used by the MSC when the MSC tries to locate a remote terminal that fails to reply to a paging message. Paging messages for such a remote terminal exchanging packets in a packet-switched portion of a communication network are broadcast in a cell on a common (circuit-switched) control channel and may also be included in a packet data stream sent directly to the terminal. The result is the same as if the circuit-switched and packet-switched portions of the network have combined procedures for mobility management, even if they do not. Paging is coordinated from the remote terminal's point of view, avoiding the problem of dropped circuit-switched calls during packet-switched operation.

### BACKGROUND

This invention relates to methods and apparatus for telecommunication and in particular to paging co-ordination in circuit-switched and packet-switched mobile communication networks.

In a packet data communication system, information is exchanged as packets of digital data, or datagrams. Each data packet includes address information that enables the system to direct each packet on its own way through the system from a sender to a receiver. Thus, a packet data communication system does not maintain a continuous connection between a sender and a receiver. Packet data communication systems are sometimes called “connection-less” and packet-switched systems, distinguishing them from common telephony systems in which continuous connections are established between senders and receivers. Thus, common telephony systems are sometimes called “connection-oriented” and circuit-switched systems.

General packet radio service (GPRS) is a packet-switched communication system that is standardized by the European Telecommunications Standards Institute (ETSI). In particular, GPRS operates with circuit-switched, cellular mobile telephone systems such as the Global System for Mobile (GSM) system, also standardized by ETSI, and the U.S. Time Division Multiple Access (TDMA) cellular system defined by the TIA/EIA-136 standard promulgated by the Telecommunications Industry Association (TIA) and Electronic Industries Association (EIA). By adding GPRS functionality to GSM and TDMA public land mobile networks (PLMNs), network operators can give their subscribers resource-efficient access to external Internet protocol-based (IP-based) networks like the Internet.

As depicted in FIG. 1, a GSM-style PLMN includes a number of interconnected network nodes, in particular, a mobile switching center/visitor location register (MSC/VLR), a home location register (HLR), and base station subsystems (BSS). The BSS handles radio communication with subscribers' mobile stations (MSs) via an air interface Um. The HLR is a database of information about the subscribers that is accessed by the MSC/VLR via a D-interface. The MSC/VLR routes circuit-switched calls to and from the MSs, communicating with the BSS over an A-interface. It will be appreciated that these nodes are typical of a circuit-switched network such as a PLMN, whether GSM or not. Data transfer and signaling interfaces are indicated in FIG. 1 by solid lines and signaling interfaces are indicated by dotted lines.

Packet data services and GPRS add nodes in a packet-switched portion of the communication network for handling packet data traffic that interwork with the circuit-switched portion of the communication system depicted in FIG. 1. For example, a serving GPRS support node (SGSN) is connected to the BSS via a Gb-interface and resides at the same hierarchical level in the network as the MSC/VLR. A gateway GPRS support node (GGSN) is the interconnection point to a packet data network (PDN) via a Gi-interface and is connected to the SGSN via a Gn-interface (which may be an IP backbone). User data to the Internet, directed for example, from a terminal equipment (TE) connected to a mobile terminal (MT), is sent encapsulated over the IP backbone. In FIG. 1, R is a reference point between a non-ISDN compatible TE and an MT. In this application, the end-user's equipment is called a mobile station (MS) whether it is a combination of a phone (MT) and a device such as a computer (TE) or just a phone. The SGSN and GGSN can be combined into one physical node and deployed at a central point in the network, or a network may include several GGSNs and SGSNs as shown. Packet data streams and short text messages are handled in FIG. 1 by a Short Message Service-GPRS MSC (SMS-GMSC) and an SMS-Interworking MSC (SMS-IWMSC) that communicate with the HLR via a C-interface and with the MSC/VLR via an E-interface. As seen in FIG. 1, the SMS-GMSC and SMS-IWMSC exchange short messages with a short message switching center (SM-SC), and the SMS-GMSC communicates with the SGSN via a Gd-interface.

Most of the interfaces depicted in FIG. 1, and in particular the Gs-and A-interfaces, exchange messages with the help of the Signaling System Number 7 (SS7) that is standardized by ETSI and the American National Standards Institute (ANSI), among others. SS7 in GSM and GPRS uses a message transfer part (MTP) protocol to deliver messages and a signaling connection control part (SCCP) protocol for extended addressing. The SCCP protocol provides for each message to have an SCCP header that has a sub-system number for telling the node receiving the message which application should have the message. An SGSN, for example, typically has different sub-system numbers for communication with the HLR and with the MSC/VLR. An MSC usually derives the node type of a communicating peer node based on the sub-system number that may be stored in a database or included in an earlier message. It will be appreciated that the nodes depicted in FIG. 1 are typical of a packet-switched network, whether a GPRS network or not.

In a GPRS network, packet data channels (PDCHs) are mapped onto respective timeslots, thereby utilizing the same physical channel structure as ordinary circuit-switched GSM/TDMA channels. All radio resources are managed from a base station controller (BSC) in the BSS, which also includes Base Transceiver Stations (BTS); the pool of physical channels for a given cell can be used as either circuit switched channels or packet-data channels. By means of packet multiplexing, the allocated PDCHs can be shared by every GPRS user in the cell, and the number of PDCHs in a cell can be fixed or dynamically allocated to meet fluctuating traffic demands. To support efficient multiplexing of packet traffic to and from mobile stations, or mobile terminals (MTs), packet data traffic channels (PDTCHs), packet associated control channels (PACCHs), and packet data common control channels (PDCCHs) are specified for the air interface Um, although PDCCHs are not always used.

The GPRS standard specifies three classes of MSs: a Class-A terminal, which supports simultaneous circuit-switched and packet-switched traffic; a Class-B terminal, which supports either circuit-switched or packet-switched traffic (simultaneous network attachment) but does not support both kinds of traffic simultaneously; and a Class-C terminal, which is attached either as a packet-switched or circuit-switched terminal. The terminal classes are further differentiated by their ability to handle multi-timeslot operation. Since Class-A and Class-B terminals support both circuit-switched and packet-switched traffic, the network may combine mobility management. For instance, location updates can include information relating to both services.

As noted above, an SGSN serves every GPRS subscriber that is physically located within the SGSN's service area. To a large extent, the SGSN does for the packet data service what the MSC/VLR does for circuit-switched service. The mobility management functions for GPRS terminals that are performed by an SGSN include attach/detach, user authentication, ciphering, location management, and so on, and an SGSN supports combined mobility management for Class-A and Class-B mobile terminals by interworking with the MSC/VLR. An SGSN also manages the logical link to mobile terminals that carries user packet traffic, SMS traffic, and layer-3 signaling between the network and the GPRS terminals. An SGSN also routes and transfers packets between mobile terminals and the GGSN; handles packet data protocol (PDP) contexts (the PDP context defines important parameters, such as the access point name, quality of service, the GGSN to be used, and so on, for connection to the external packet data network); interworks with the radio resource management in the BSS; and generates charging data.

As noted above, the GGSN accommodates the interface to external IP-based networks. Access-server functionality in the GGSN is defined according to standards from the Internet Engineering Task Force (IETF). The GGSN functions as a border gateway between the PLMN and external networks; sets up communication with external packet data networks; authenticates users to external packet networks; routes and tunnels packets to and from the SGSN; and generates charging data.

The MSC/VLR also supports integrated mobility management for Class-A and Class-B mobile terminals. GPRS attach and PDP-context activation must be executed in order for GPRS users to connect to external packet data networks. The mobile terminal makes itself known to the network by means of GPRS attach, which corresponds to IMSI attach used for circuit-switched traffic. Once the terminal is attached to the network, the network knows its location and capabilities. If the mobile terminal is a Class-A or Class-B terminal, then circuit-switched IMSI attach and packet switched GPRS attach can be performed at the same time.

GPRS attach is depicted by FIG. 2. In step 1, the mobile terminal requests that it be attached to the network. The terminal's request, which is sent to the SGSN, indicates its multi-timeslot capabilities, the ciphering algorithms it supports, and whether it wants to attach to a packet-switched service or to both packet and circuit-switched services. In step 2, authentication is made between the terminal and the HLR. In step 3, subscriber data from the HLR is inserted into the SGSN; and in step 4, information is passed to the terminal that it is attached to the network.

Before the mobile terminal can communicate with an external PDN (e.g., an IP network), a PDP context must be activated. The PDP context describes the characteristics of the connection to the external PDN, e.g., type of network, network address, access point name (APN), QoS, and so on. PDP-context activation is depicted in FIG. 3. In step 1, the mobile terminal requests PDP-context activation. In step 2, the SGSN validates the request based on subscription information received from the HLR during GPRS attach. In step 3, the APN is sent to a domain name server (DNS) in the SGSN to find the IP address of the relevant GGSN. In step 4, a logical connection is created between the SGSN and the GGSN (i.e., a GPRS Tunneling Protocol (GTP) tunnel is formed). In step 5, the GGSN assigns a dynamic IP address to the mobile terminal from the range of IP addresses allocated to the PLMN or externally, from a Remote Authentication Dial-In User Service (RADIUS) server (a fixed IP address from the HLR could also be used). A RADIUS client is included in the GGSN to support Password Authentication Protocol (PAP) and Challenge Handshake Authentication Protocol (CHAP) authentication to external networks with RADIUS servers. At this stage, communication between the user and the external PDN (e.g., an Internet Service Provider (ISP) network or a corporate network) can commence (step 6).

The Gs-interface between the MSC/VLR and the SGSN is standardized and is used for combined mobility management procedures between circuit-switched nodes and packet-switched nodes. The GSM/GPRS specification, “Digital Cellular Telecommunications System (Phase 2+); General Packet Radio Service (GPRS); Service Description”, GSM 03.60 (ETSI), specifies three Network Modes of Operation that depend on whether the Gs-interface exists (Mode 1) or not (Modes 2 or 3) and if PDCCH are supported (Mode 2) or not (Mode 3). The Network Mode of Operation is broadcast in all cells so that all MSs that camp in this part of the network are aware of whether combined mobility management procedures should be used or not. An important issue is that combined paging in both the circuit-switched and packet-switched networks is used only for Network Mode of Operation 1.

The MSC/VLR pages an MS in the event of a call directed to the mobile terminal by sending a Page message to the BSC using the A-interface and the Base Station System Application Part (BSSAP) protocol if the Gs-interface does not exist or if the user is not GPRS-attached. The BSC then arranges for the Page message to be broadcast on a GSM (circuit-switched) paging channel. This is the traditional non-GPRS solution for a GSM system, and is typical of other types of PLMN as well.

An MS that is both IMSI-and GPRS-attached with Network Mode of Operation 1 (the Gs-interface exists) is paged from the SGSN instead of the MSC when the MS receives a call. Thus, the MSC/VLR does not send a Page message to the BSC but instead sends a Paging Request message according to a BSSAP+ protocol to the SGSN over the Gs-interface. The SGSN processes the Paging Request message in order to find the location of the MS before sending a CS Paging message to the BSC, which then arranges for the MS to be paged.

A problem arises in networks with Network Modes of Operation 2 or 3, where the Gs-interface is missing. An MS that is both IMSI-and GPRS-attached does not monitor the GSM paging channel while it is sending or receiving packet data. In Packet Transfer Mode, the MS has an ongoing Temporary Block Flow (TBF). Thus, a call directed to the MS will not be answered (i.e., the MS will not hear the paging message), and the call will be routed according to the MS subscriber information in the HLR, in particular, the “MS not reachable” information. This can cause revenue to be lost since paging is not coordinated between the circuit and packet-switched parts of the network.

### SUMMARY

In accordance with the invention, paging messages for an MS having an active TBF are broadcast in a cell on a common (circuit-switched) control channel and are also included in a packet data stream sent directly to the MS. The result is therefore the same as if the network were running in Network Mode of Operation 1 even though the network is running in either Network Mode of Operation 2 or Network Mode of Operation 3, in which the SGSN and MSC/VLR do not have combined procedures for mobility management. Paging is nevertheless coordinated from the MS's point of view, avoiding the problem of dropped circuit-switched calls during packet-switched operation.

In one aspect of the invention, the SGSN is registered in the MSC/VLR as a “virtual” BSC instead of as a SGSN. The virtual BSC has one virtual cell with a unique Location Area identity. No MS is ever registered in the MSC/VLR as physically present in the unique Location Area, but the unique Location Area is included in the search area used by the MSC/VLR when the MSC/VLR tries to locate an MS that fails to reply to a paging message.

In another aspect of the invention, a method in an SGSN of coordinating page messages directed to MSs includes the steps of monitoring a virtual A-interface between the SGSN and an MSC; verifying that a page message has been received by the SGSN via the virtual A-interface; determining whether an MS to which the received page message is directed is GPRS attached; and if the MS to which the received page message is GPRS attached, sending a GPRS page message to a BSC that is in communication with the MS. In this method, the GPRS page message may be sent over a Gb-interface between the SGSN and the BSC. The determining step may also include processing the received page message in accordance with a BSSAP+ protocol and the GPRS page message may be a CS Paging message.

In another aspect of the invention, there is provided a method of co-ordinating page messages directed to MSs in a network having a packet-switched portion and a circuit-switched portion. In an MSC in the circuit-switched portion, an SGSN is registered as a node in the circuit-switched portion and monitors a virtual A-interface between the SGSN and the MSC. The SGSN verifies that a circuit-switched page message has been received by the SGSN via the virtual A-interface and determines whether an MS to which the received page message is directed is attached to the packet-switched portion. If the MS to which the received page message is directed is attached to the packet-switched portion, the SGSN sends a packet-switched page message to a BSC in communication with the MS.

In this method, the packet-switched page message may be sent over a Gb-interface between the SGSN and the BSC. The determining step may include processing the received page message in accordance with a BSSAP+ protocol, and the packet-switched page message may be a CS Paging message. The method may further include sending a paging response from the MS in the circuit-switched portion, and terminating a Temporary Block Flow of the MS.

### BRIEF DESCRIPTION OF THE DRAWINGS

The features, objects, and advantages of this invention will be apparent from reading this description in conjunction with the drawings, in which:

FIG. 1 depicts a combined packet-switched and circuit-switched communication network;

FIG. 2 depicts GPRS attach in a packet-switched network;

FIG. 3 depicts PDP context activation in a packet-switched network;

FIG. 4 is a flowchart of a method in accordance with Applicants' invention; and

FIGS. 5A-5G depict procedures in a network in accordance with Applicants' invention.

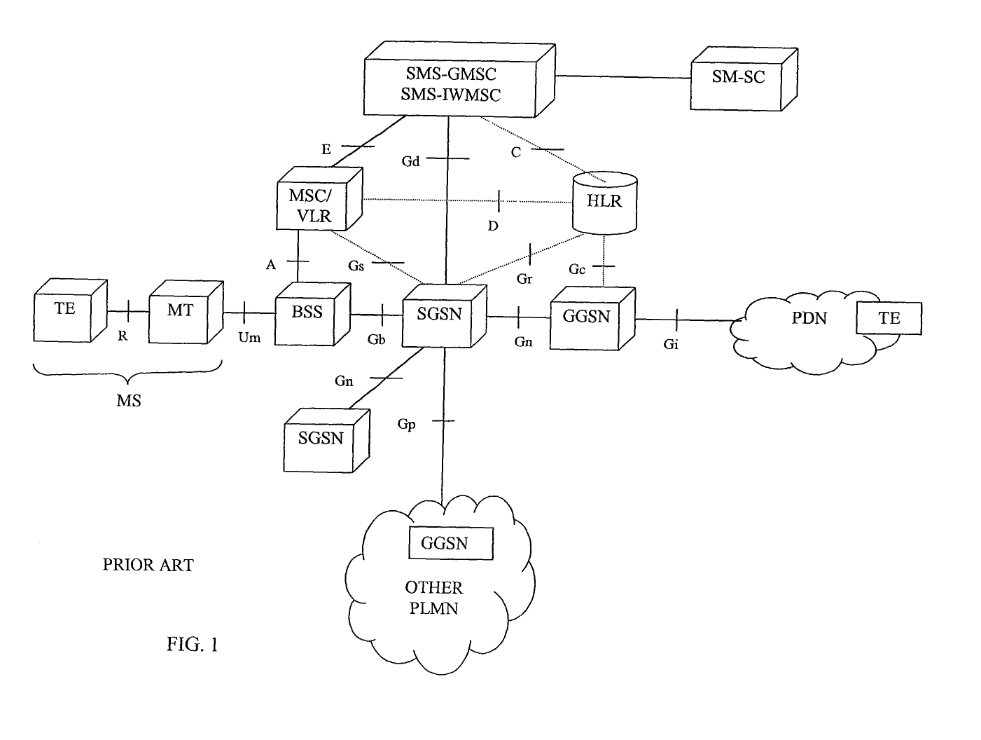

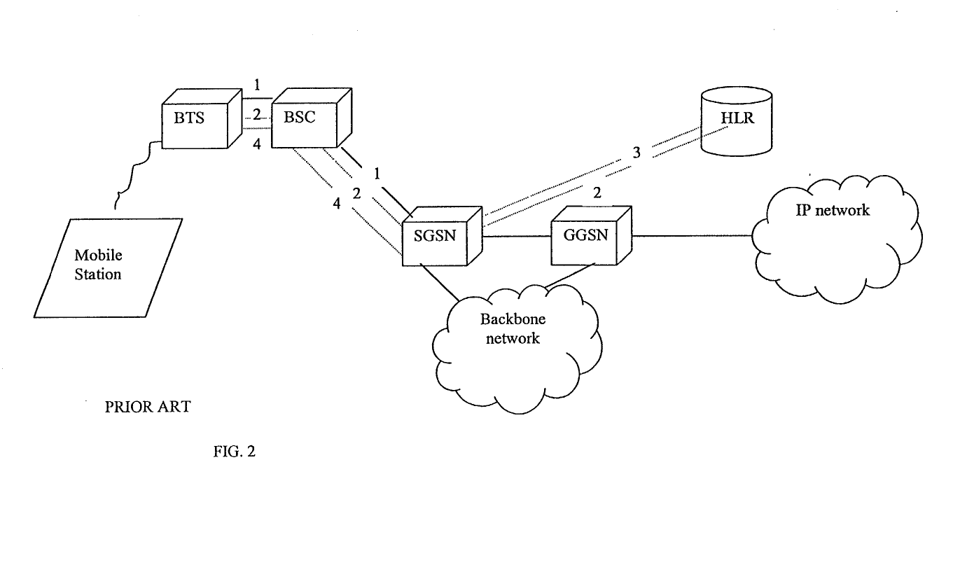

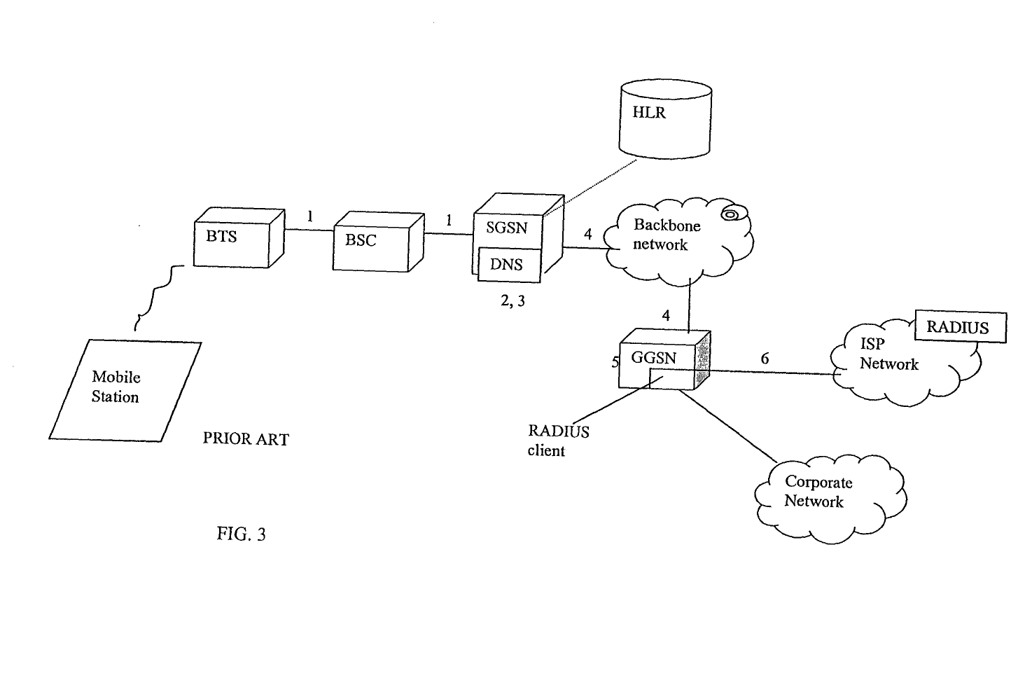

### DETAILED DESCRIPTION

This description is given in terms of GPRS in a GSM network for convenience only, and it will be appreciated that the principles of the invention can be applied in other networks having circuit-switched and packet-switched portions with suitable characteristics.

In accordance with Applicants' invention, the MSC/VLR or an equivalent node in a circuit-switched portion of a communication network sends paging messages to the SGSN or an equivalent node in a packet-switched portion of the network, even without the combined procedures for mobility management that are typical of Network Mode of Operation 1. This is done by registering the SGSN in the MSC/VLR as a “virtual” BSC or equivalent having one “virtual” cell. Every MSC maintains a list of cells with their BSCs' MTP or SCCP addresses, and the SGSN's MTP or SCCP address and “virtual” cell identity would be added to this list to register the SGSN.

From the MSC/VLR's point of view, its interface to the “virtual” BSC (real SGSN) is thus simply an A-interface rather than a Gs-interface, and the ones of the messages and procedures specified for the A-interface, e.g., by “Digital Cellular Telecommunications System (Phase 2+); Mobile-services Switching Centre-Base Station System (MSC-BSS) Interface Layer 3 Specification”, GSM 08.08 (ETSI) for BSSAP are used rather than the messages and procedures specified for the Gs-interface, e.g., by “Digital Cellular Telecommunications System (Phase 2+); General Packet Radio Service (GPRS); Serving GPRS Support Node (SGSN)-Visitors Location Register (VLR) Gs Interface Layer 3 Specification”, GSM 09.18 (ETSI) for BSSAP+. In reality, the sub-system number associated with BSSAP is used instead of the sub-system number for BSSAP+ for the messages between the MSC and SGSN. In particular, the circuit-switched messages on the “virtual” A-interface need only be paging and reset messages. In addition, no MS is registered in the VLR as present in the virtual cell, since the cell does not exist in fact, and thus the MSC/VLR does not send paging messages over this virtual A-interface in a first attempt to find the MS. Moreover, the procedures and messages for setting up a circuit-switched connection over this virtual A-interface also are not needed.

When an MSC/VLR receives an Initial Address message from a GMSC seeking an MS, it initiates a Page_MS procedure by paging the MS in the Location Area in which the MS is registered in the MSC/VLR. If the MS does not answer the first Page message broadcast in the registered Location Area, e.g., because the MS is in Packet Transfer Mode, a “Search_For_MS” procedure starts in the VLR in order to find the MS, as specified in “Digital Cellular Telecommunications System (Phase 2+); Basic Call Handling; Technical Realization”, GSM 03.18 (ETSI). The procedure “Search_For_MS” in the VLR initiates a second paging in the whole MSC Service Area, which in accordance with Applicants' invention, includes the virtual BSC, i.e., the SGSN. All second-paging, Global Page messages are therefore sent to the SGSN (acting as a virtual BSC) as well as the real BSCs, and thus the circuit-switched second-paging messages can reach an MS involved in a TBF since the SGSN sends packet-switched counterparts of the circuit-switched second-paging messages to GPRS-attached MSs via the packet data control channels.

If the SGSN accepts the paging request, the SGSN processes the Global Page message in a manner similar to the manner it processed a BSSAP+ Paging Request message before sending the paging message to the (real) BSC. One result of this processing of a circuit-switched Global Page message is the packet-switched CS Paging message (see GSM 08.18) that the SGSN sends to the BSS via the Gb-interface.

Thus, it will be understood that a paging message directed to an MS that is both IMSI-and GPRS-attached is sent to the correct BSC as a paging request message. The BSC either broadcasts the paging request message in the Routing Area or sends it to the MS on the PDCCH if the MS is in Packet Transfer Mode, since the BSC knows whether the MS is in Packet Transfer Mode. An MS that receives a CS Paging message will notify the end-user about an incoming call so that the end-user can terminate the TBF, if necessary, and take the call.

It will be recognized that in this arrangement, the SGSN receives second-paging messages for all MSs that do not respond to first-paging messages, even for MSs that are not GPRS-attached. Those messages may simply be discarded by the SGSN since the MSC/VLR does not expect or need to receive paging-reject messages from a BSC, even if it is a “virtual” BSC.

It will be appreciated that Applicants' invention requires no changes to be made in the MSC/VLR, which does not even need to be aware of the presence of an SGSN in the network. Thus, older MSCs made by different manufacturers can operate perfectly well with enhanced GPRS functionality.

From an SGSN's point of view, the standard Gs-interface is simply replaced by the standard (virtual) A-interface. The SGSN needs only slight modification to enable it to monitor the virtual A-interface for Global Page messages or the like from the MSC/VLR. Since the A-interface is a standardized interface in the circuit-switched portion of the network, such modifications are readily implemented with software in the SGSN that takes into account the relative simplicity of the virtual A-interface with respect to the Gs-interface. It is necessary for the SGSN only to monitor the virtual A-interface for Global Page and Reset messages that are intended for GPRS-attached MSs. Thus, the virtual A-interface can be primarily a one-way interface, from the MSC/VLR to the SGSN, rather than a two-way interface like the standard Gs-interface, which carries messages for synchronizing subscriber information databases maintained by the MSC/VLR and SGSN.

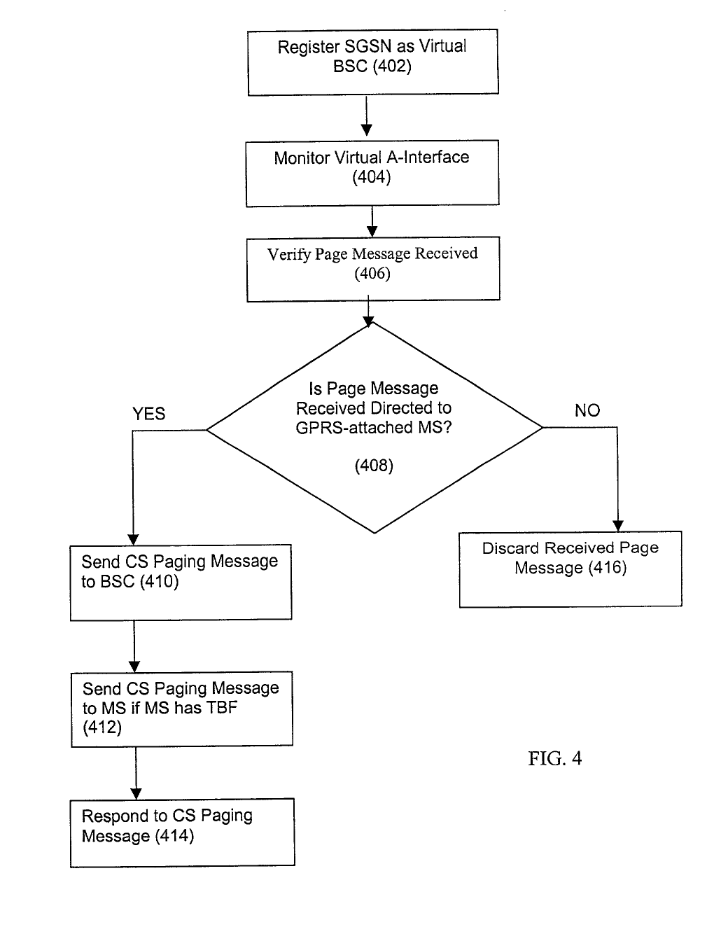

As depicted by the flowchart of FIG. 4, a modified SGSN is registered in the MSC/VLR as a virtual BSC having a virtual cell (step 402), and then monitors the virtual A-interface (step 404). The SGSN verifies that a Page message has been received (step 406), and determines whether the subscriber/MS to whom the received Page message is directed is GPRS attached (step 408). If so, the SGSN sends a CS Paging message to the appropriate BSC via, for example, the Gb-interface (step 410), and then waits for the next message to arrive on the virtual A-interface. The appropriate BSC forwards the CS Paging message to the appropriate MS (step 412), via a PDCCH for example, if the MS is in Packet Transfer Mode (i.e., the MS has a Temporary Block Flow), and the MS responds to the BSC with an appropriate message on the circuit-switched Random Access Channel (RACH) (step 414), which may require the MS to terminate its Temporary Block Flow. If the Page message received by the SGSN is not directed to a GPRS-attached MS, the SGSN simply discards the received Page message, e.g., by doing nothing (step 416).

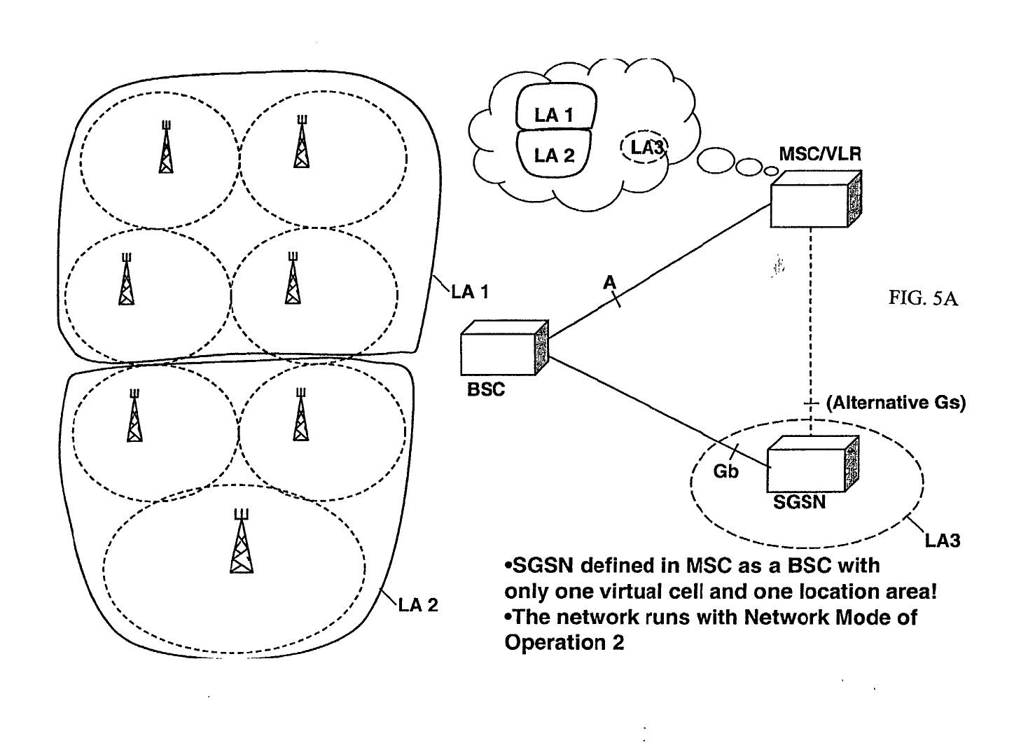

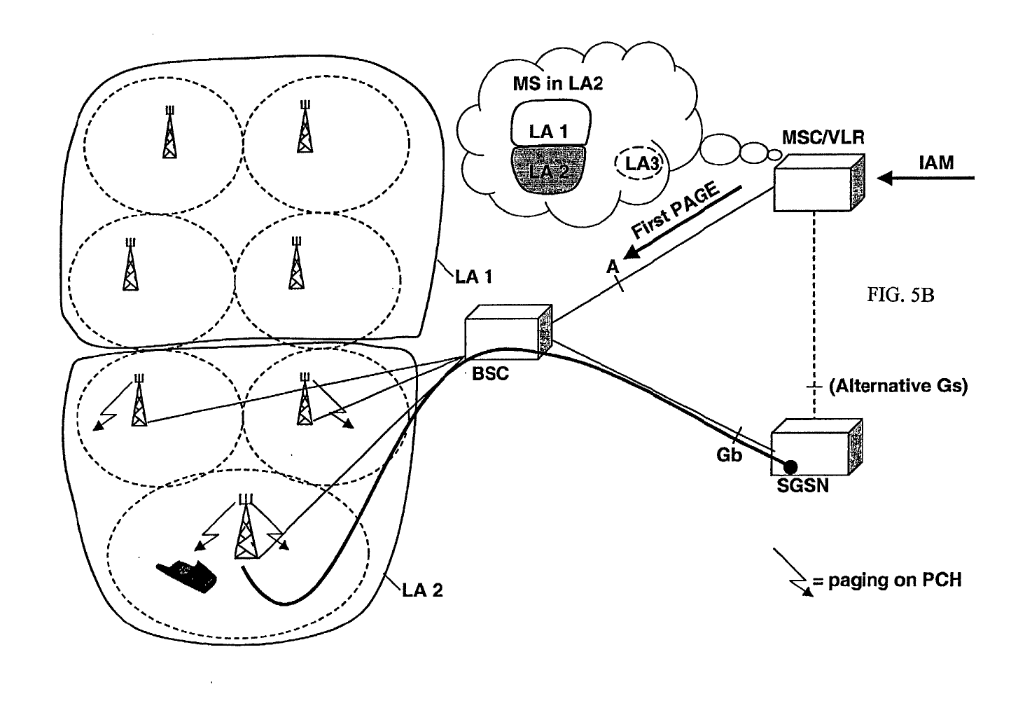

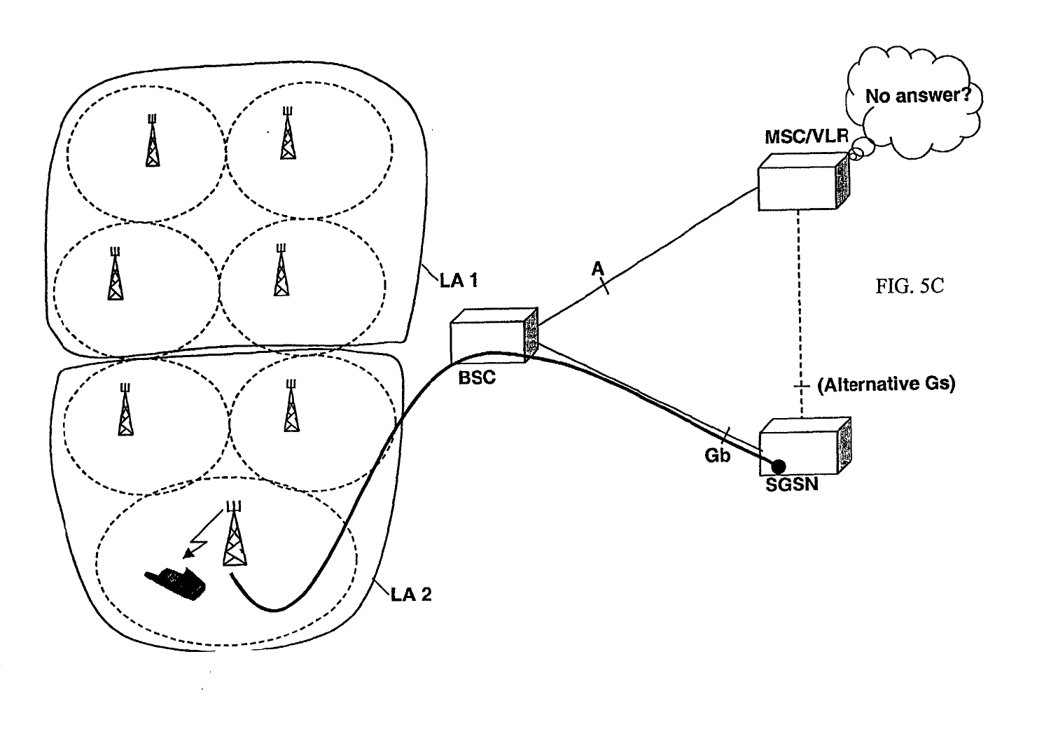

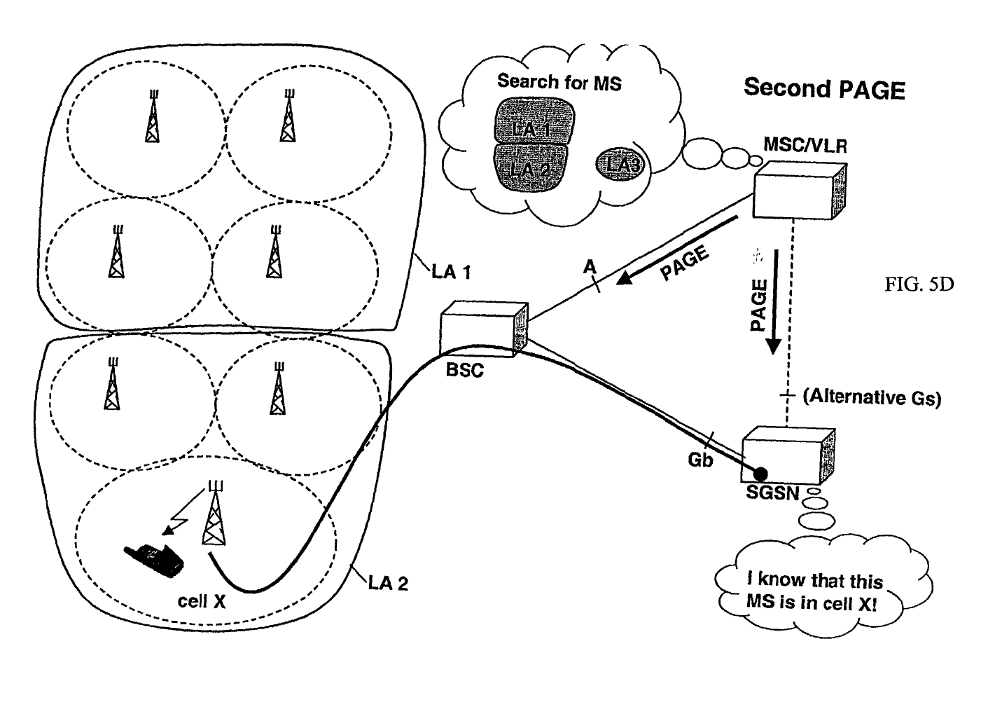

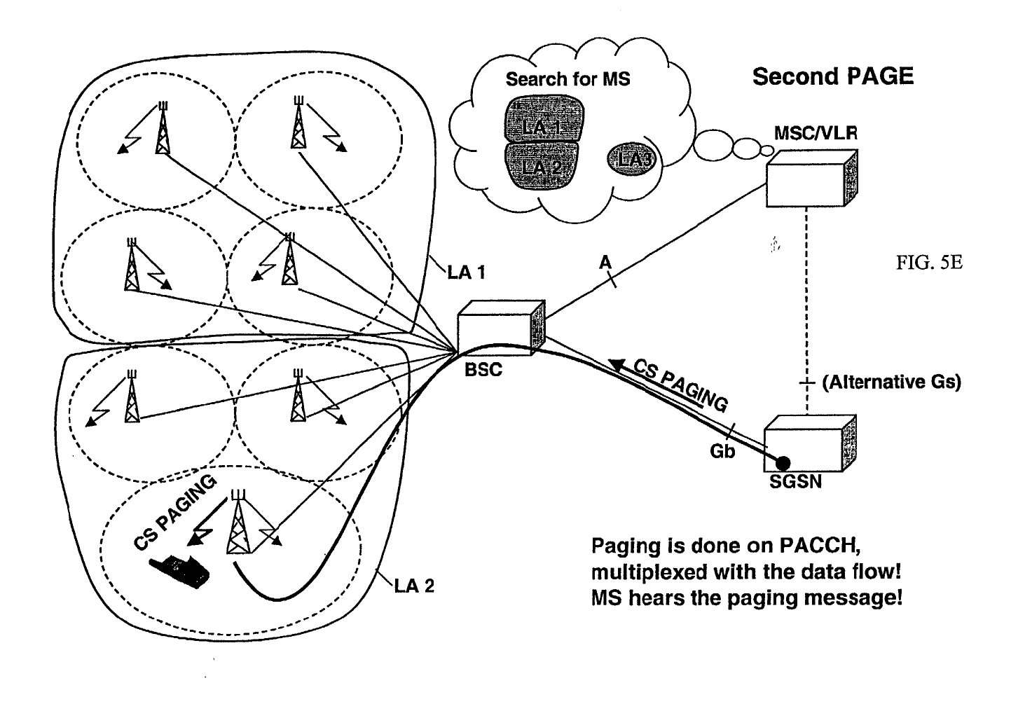

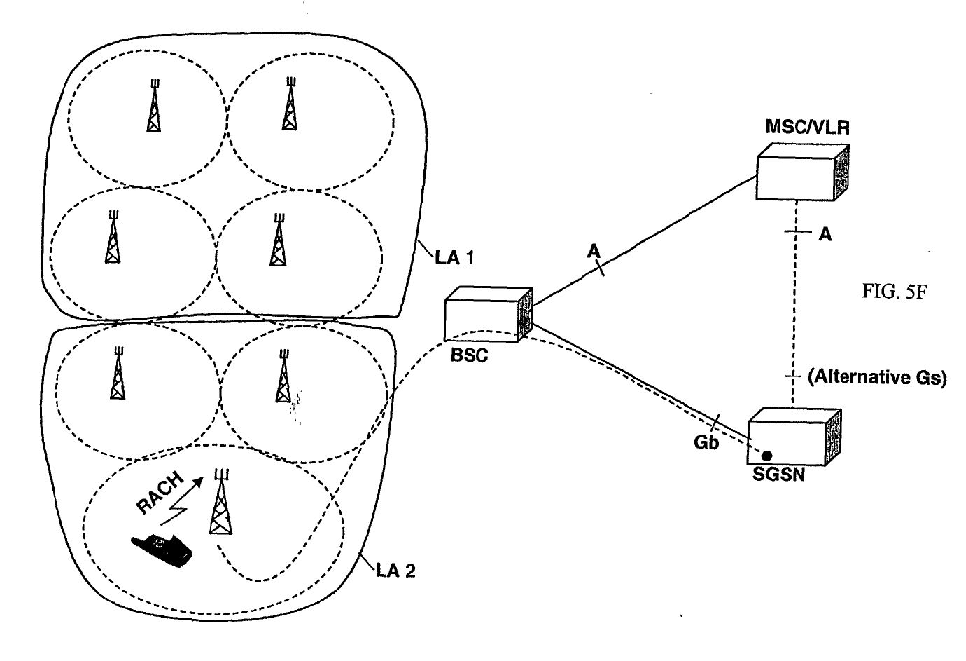

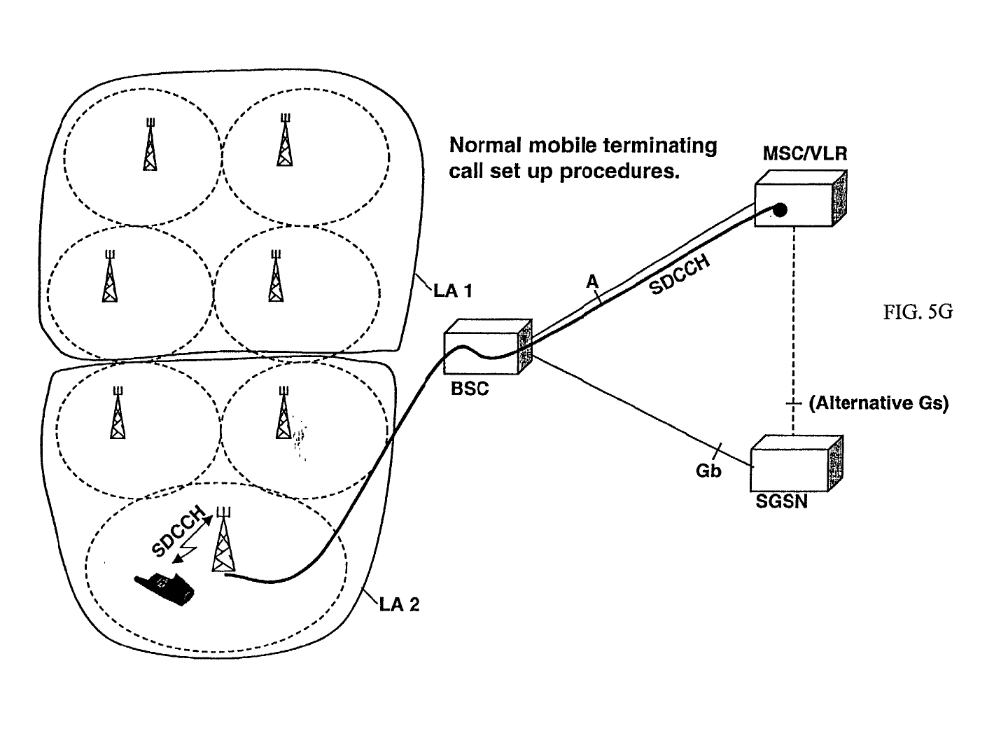

As a further explanation of Applicants' invention, a simplified example of a traffic case is described below in connection with FIGS. 5A-5G.

To begin, FIG. 5A schematically depicts a network having circuit-switched and packet-switched portions that include an MSC/VLR, a BSC, and an SGSN that are interconnected by an A-, Gb-, and virtual (alternative) Gs-interfaces. The MSC/VLR is aware of Location Area (LA) 1 and LA 2 served by the BSC, as well as other LAs such as LA 3. Within LA 1 and LA 2 are individual cells served by base transceiver stations that are indicated by the dotted-line circles and included antenna tower icons. As shown in FIG. 5A, the SGSN is also included in a dotted-line circle to represent its status in the MSC as a BSC having one virtual cell.

As depicted in FIG. 5B, the MSC receives an Initial Address Message (IAM) from a GMSC that includes a Temporary Mobile Station Identification (TMSI) number allocated to the MS. The MSC pages the MS in the LA in which the MS is registered in the VLR (in FIG. 5B, that is LA 2) by directing a First Page message to the appropriate BSC that causes the Page to be broadcast in the cells of the LA. The MS may not respond to these pages for several reasons: the MS is out of reach of the PLMN (e.g., in an area of no coverage or with no battery power); the MS is not in the registered LA(s) but in another one; the BSS does not detect the MS's responses to the pages; or the MS, if GPRS attached, is in Packet Transfer Mode. The last condition is indicated in FIG. 5B by the solid line between the SGSN and the cell including the representation of an MS.

Since the MS is in Packet Transfer Mode, the MS will not respond to the Page message in Network Modes of Operation 2 and 3. This leaves the MSC/VLR waiting for a response as depicted in FIG. 5C. If the MS does not respond to a first paging, the MSC does a second paging in the MSC's whole Service Area as depicted in FIG. 5D, e.g., by broadcasting a Global Page message. The MS may not respond to the second Page message if the MS is still out of reach, etc., or the MS may respond if it is in an LA belonging to the MSC or if its TBF has ended, i.e., the MS is in Packet Idle Mode. In either case, the SGSN receives via the virtual A-interface (alternative Gs-interface) the second paging Page message that is addressed to the virtual BSC since the virtual cell is a part of the MSC Service Area.

As part of its normal operation, the SGSN knows the location of the MS. Accordingly as depicted in FIG. 5E, the SGSN sends its own CS Paging message, if the MS is GPRS attached, to the BSC covering the GPRS Roaming Area in which the MS is registered in the SGSN. The BSC either broadcasts the CS Paging message in the Roaming Area or sends it directly to the MS if the BSC knows the cell in which the MS is located. As depicted in FIG. 5F, the MS can now respond with a message on the (circuit-switched) RACH even if it is still in Packet Transfer Mode if it is a Class-B terminal or by terminating packet transfer (i.e., terminating its Temporary Block Flow) if it is a Class-C terminal. It will be recognized that the MS's Page Response message will reach the MSC/VLR via a real BSC rather than the virtual BSC to initiate a circuit-switched session as depicted by the solid line in FIG. 5G.

Among the merits of the invention are that operators can avoid losses due to absent Gs-interfaces and that coordinated paging can be implemented without a need for Gs-interface support in the MSC/VLR or SGSN.

Applicants' invention is described above in connection with various embodiments that are intended to be illustrative, not restrictive. It is expected that those of ordinary skill in this art will modify these embodiments. The scope of Applicants' invention is defined by the following claims, and all modifications that fall within the scopes of these claims are intended to included therein.

What is claimed is:

1. A method in a serving General Packet Radio Service support node (SGSN) of coordinating page messages directed to Mobile Stations, comprising the steps of:
monitoring a virtual A-interface between the SGSN and a Mobile Switching Center;
verifying that a circuit-switched page message has been received by the SGSN via the virtual A-interface;
determining whether a Mobile Station to which the received page message is directed is GPRS attached; and
if the Mobile Station to which the received page message is GPRS attached, sending a GPRS page message to a Base Station Controller in communication with the Mobile Station.

2. The method of claim 1, wherein the GPRS page message is sent over a Gb-interface between the SGSN and the Base Station Controller.

3. The method of claim 1, wherein the determining step includes the step of processing the received page message in accordance with a BSSAP+ protocol and the GPRS page message is a CS Paging message.

4. A method of coordinating page messages directed to Mobile Stations in a network having a packet-switched portion and a circuit-switched portion, comprising the steps of:
registering, in a Mobile Switching Center (MSC) in the circuit-switched portion, a serving General Packet Radio Service support node (SGSN) as a node in the circuit-switched portion;
monitoring a virtual A-interface between the SGSN and the MSC;
verifying that a circuit-switched page message has been received by the SGSN via the virtual A-interface;
determining whether a Mobile Station to which the received page message is directed is attached to the packet-switched portion; and
if the Mobile Station to which the received page message is directed is attached to the packet-switched portion, sending a packet-switched page message to a Base Station Controller in communication with the Mobile Station.

5. The method of claim 4, wherein the packet-switched page message is sent over a Gb-interface between the SGSN and the Base Station Controller.

6. The method of claim 4, wherein the determining step includes the step of processing the received page message in accordance with a BSSAP+ protocol and the packet-switched page message is a CS Paging message.

7. The method of claim 4, further comprising the step of sending a paging response from the Mobile Station in the circuit-switched portion.

8. The method of claim 7, wherein the step of sending a response includes terminating a Temporary Block Flow of the Mobile Station.
